(19) United States
(12) Patent Application Publication
(10) Pub. No.: US 2017/0024430 A1
(43) Pub. Date: Jan. 26, 2017

(54) SYSTEMS AND METHODS FOR ATTRIBUTING TEXT PORTIONS TO CONTENT SOURCES BASED ON TEXT ANALYSIS

(71) Applicant: Facebook, Inc., Menlo Park, CA (US)

(72) Inventors: Avichal Garg, Palo Alto, CA (US); Vojin Katic, Palo Alto, CA (US)

(21) Appl. No.: 14/809,027

(22) Filed: Jul. 24, 2015

(51) Int. Cl. G06F 17/30; G06F 9/54; G06F 3/0484

(52) U.S. Cl. CPC G06F 17/30386; G06F 3/0484; G06F 9/543

(57) ABSTRACT

Systems, methods, and non-transitory computer-readable media can acquire a text portion to be included in a communication. A search of text associated with a set of content sources can be requested. An identification of a subset of one or more content sources, out of the set of content sources, that are each associated with respective text that at least meets a specified threshold confidence level of matching the text portion can be received. Information associated with a selected content source out of the subset can be provided for inclusion in the communication. The information can suggest, at least in part, that the text portion is attributable to the selected content source.

### FIELD OF THE INVENTION

The present technology relates to the field of providing content. More particularly, the present technology relates to techniques for attributing text portions to content sources based on text analysis.

### BACKGROUND

Today, people often utilize computing devices (or systems) for a wide variety of purposes. Users can use their computing devices, for example, to interact with one another, access content, share content, and create content. In some cases, users can utilize their computing devices to view, read, or browse through content, such as via web sites and other content sources. In some instances, users can also utilize their computing devices to provide, publish, or post content, such as via a social networking system (or service). For example, a user can use his or her computing device to read an article and then create and share, via the social networking system, a post about the article.

Under conventional approaches, users often create and share posts based on content provided by various content sources. However, in accordance with conventional approaches, there can be a lack of additional information provided with the posts based on the content from the various content sources. For instance, conventional approaches generally fail to provide a sufficient amount of information to indicate that a particular piece of content in a post is attributable to a particular content source. As such, conventional approaches can create challenges for or reduce the overall user experience associated with providing attributable content.

### SUMMARY

Various embodiments of the present disclosure can include systems, methods, and non-transitory computer readable media configured to acquire a text portion to be included in a communication. A search of text associated with a set of content sources can be requested. An identification of a subset of one or more content sources, out of the set of content sources, that are each associated with respective text that at least meets a specified threshold confidence level of matching the text portion can be received. Information associated with a selected content source out of the subset can be provided for inclusion in the communication. The information can suggest, at least in part, that the text portion is attributable to the selected content source.

In an embodiment, providing, for inclusion in the communication, the information associated with the selected content source can further comprise providing a preview media content item associated with the selected content source. A preview text portion associated with the selected content source can be provided. Access to the selected content source can be provided.

In an embodiment, an option to remove, from the communication, at least some of the information associated with the selected content source can be provided.

In an embodiment, the subset of the one or more content sources can be ranked based on a respective likelihood of each content source in the subset being relevant with respect to a user who initiates the communication.

In an embodiment, the selected content source can correspond to a highest ranked content source out of the subset.

In an embodiment, the selected content source can be identified by a user who initiates the communication.

In an embodiment, the text portion can be acquired based on a paste operation from a user who initiates the communication.

In an embodiment, requesting the search of the text associated with the set of content sources can be initiated when at least a specified threshold amount of text is present in the text portion.

In an embodiment, at least one of a tag for an entity represented in a social networking system or a link to the entity represented in the social networking system can be provided. The entity can be associated with the selected content source.

In an embodiment, the set of content sources can include at least one content source that has been shared via a social networking system.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content source attribution module configured to facilitate attributing text portions to content sources based on text analysis, according to an embodiment of the present disclosure.

FIG. 2A illustrates an example content source module configured to facilitate attributing text portions to content sources based on text analysis, according to an embodiment of the present disclosure.

FIG. 2B illustrates an example information providing module configured to facilitate attributing text portions to content sources based on text analysis, according to an embodiment of the present disclosure.

FIG. 3 illustrates an example block diagram associated with attributing text portions to content sources based on text analysis, according to an embodiment of the present disclosure.

FIG. 4A illustrates an example scenario associated with attributing text portions to content sources based on text analysis, according to an embodiment of the present disclosure.

FIG. 4B illustrates an example scenario associated with attributing text portions to content sources based on text analysis, according to an embodiment of the present disclosure.

FIG. 4C illustrates an example scenario associated with attributing text portions to content sources based on text analysis, according to an embodiment of the present disclosure.

FIG. 5 illustrates an example method associated with attributing text portions to content sources based on text analysis, according to an embodiment of the present disclosure.

FIG. 6 illustrates an example method associated with attributing text portions to content sources based on text analysis, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Attributing Text Portions to Content Sources Based on Text Analysis

People use computing devices (or systems) for various purposes. Computing devices can provide different kinds of functionality. Users can utilize their computing devices to create or produce content, such as by creating text, taking pictures, or recording videos. Users can also use their computing devices to consume content, such as by reading status updates, browsing through articles, viewing media, or accessing web resources (e.g., web sites, online services, etc.).

Under conventional approaches, computing devices can enable users to generate and publish posts about various topics or subjects. In some cases, conventional approaches can enable users to generate and publish posts based on content provided by a content source. In one example, a user of a computing device can copy and paste a snippet or portion of text from a webpage into a post to be shared by the user via a social networking system (or service). However, under conventional approaches rooted in computer technology, such posts including snippets or portions of text can, in many cases, be published or shared without providing additional information about the snippets or portions of text. For instance, such conventional approaches can often times provide insufficient detail regarding to which content source(s) the snippet or portion of text is to be attributed. Therefore, such conventional approaches can cause inconvenience and inefficiency.

Due to these or other concerns, conventional approaches can be disadvantageous or undesirable. Therefore, an improved approach can be beneficial for addressing or alleviating various drawbacks associated with conventional approaches. Based on computer technology, the disclosed technology can attribute text portions to content sources based on text analysis. Various embodiments of the present disclosure can acquire a text portion to be included in a communication. A search of text associated with a set of content sources can be requested. An identification of a subset of one or more content sources, out of the set of content sources, that are each associated with respective text that at least meets a specified threshold confidence level of matching the text portion can be received. Information associated with a selected content source out of the subset can be provided for inclusion in the communication. The information can suggest, at least in part, that the text portion is attributable to the selected content source. It is contemplated that there can be many variations and/or other possibilities.

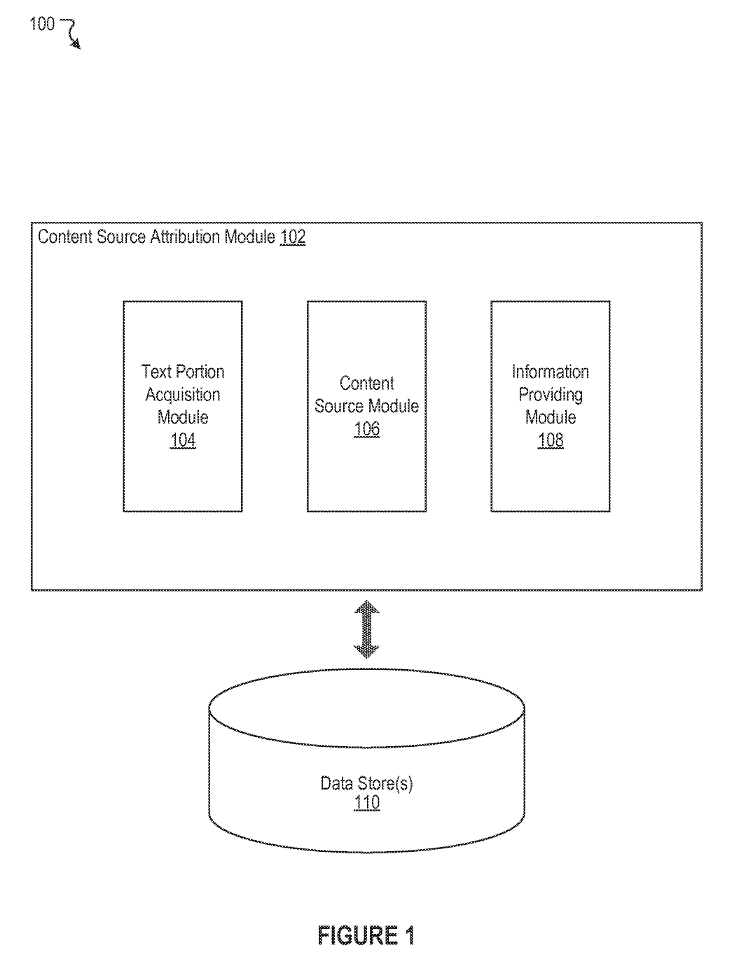

FIG. 1 illustrates an example system 100 including an example content source attribution module 102 configured to facilitate attributing text portions to content sources based on text analysis, according to an embodiment of the present disclosure. As shown in the example of FIG. 1, the content source attribution module 102 can include a text portion acquisition module 104, a content source module 106, and an information providing module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

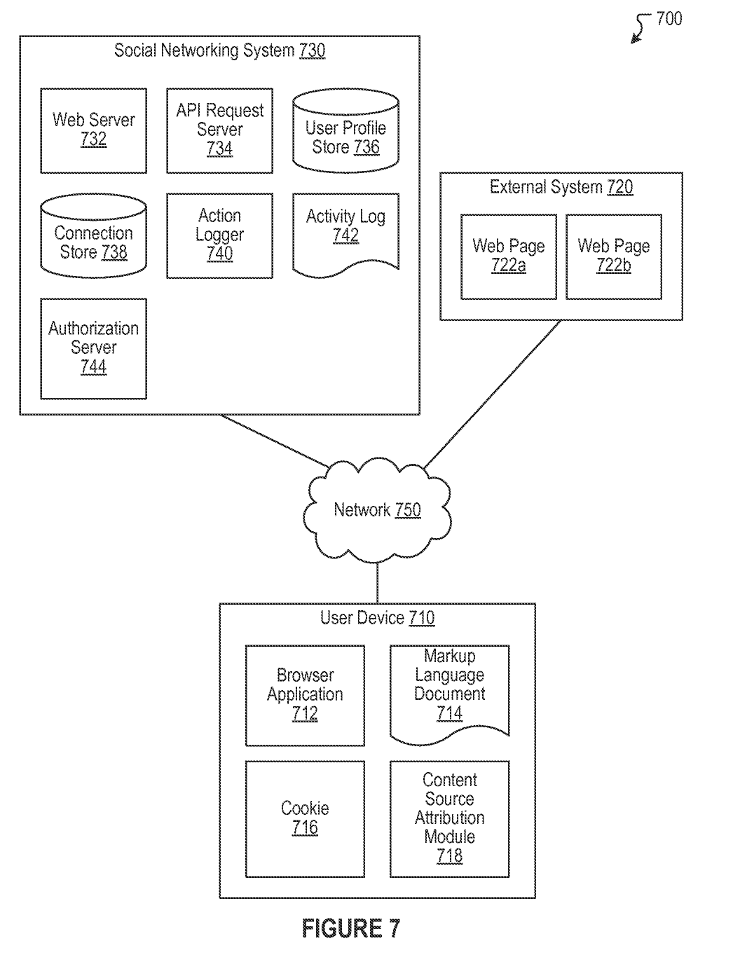

In some embodiments, the content source attribution module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content source attribution module 102 can be implemented, in part or in whole, as software running on one or more computing devices or systems, such as on a user or client computing device. For example, the content source attribution module 102 or at least a portion thereof can be implemented as or within an application (e.g., app), a program, an applet, or an operating system, etc., running on a user computing device or a client computing system, such as the user device 710 of FIG. 7. In another example, the content source attribution module 102 or at least a portion thereof can be implemented using one or more computing devices or systems that include one or more servers, such as network servers or cloud servers. In some instances, the content source attribution module 102 can, in part or in whole, be implemented within or configured to operate in conjunction with a social networking system (or service), such as the social networking system 730 of FIG. 7. It should be understood that there can be many variations or other possibilities.

The text portion acquisition module 104 can be configured to facilitate acquiring a text portion to be included in a communication. The text portion can be acquired via a text input field, such as that included with a composer element, a messaging window, a communications component, a document editor, or another input interface. In one example, a user of a computing device (or system) can initiate a communication, such as a post, a share, a message, and/or a chat, via a social networking system (or service). The text portion can be inputted by the user of the computing device who initiates the communication. In this example, the text portion acquisition module 104 can be part of an application or other software running on the computing device, such as an app for the social networking system. The user can input the text portion and share the text portion via the social networking system in the form of a post, a message, and/or another communication.

In some instances, the text portion can be typed, electronically written, or dictated, etc., by the user. In some cases, the text portion can be acquired based on a paste operation from the user. For instance, the user can copy or cut the text portion from a particular content source and then paste the text portion into the text input field. The user can then transmit, share, or publish the communication including the text portion. However, as discussed previously, the communication including the text portion may be lacking in additional information regarding the text portion, such as information indicating that the text portion is attributable to the particular content source from which the text portion was copied or cut. Accordingly, the disclosed technology can, for example, attribute the text portion to the particular content source based on text analysis, such as by searching and matching text.

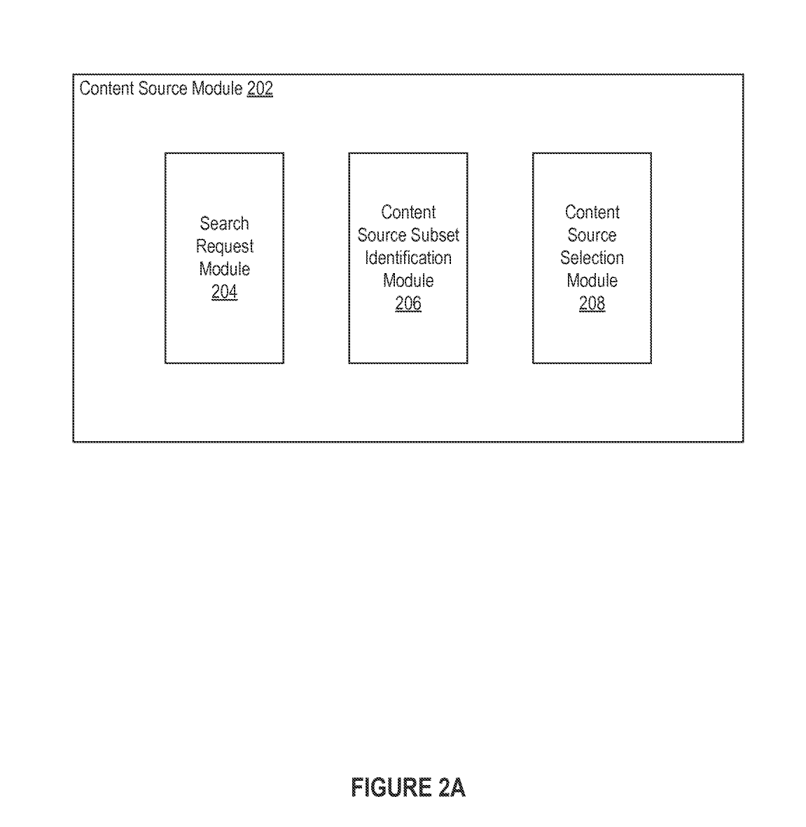

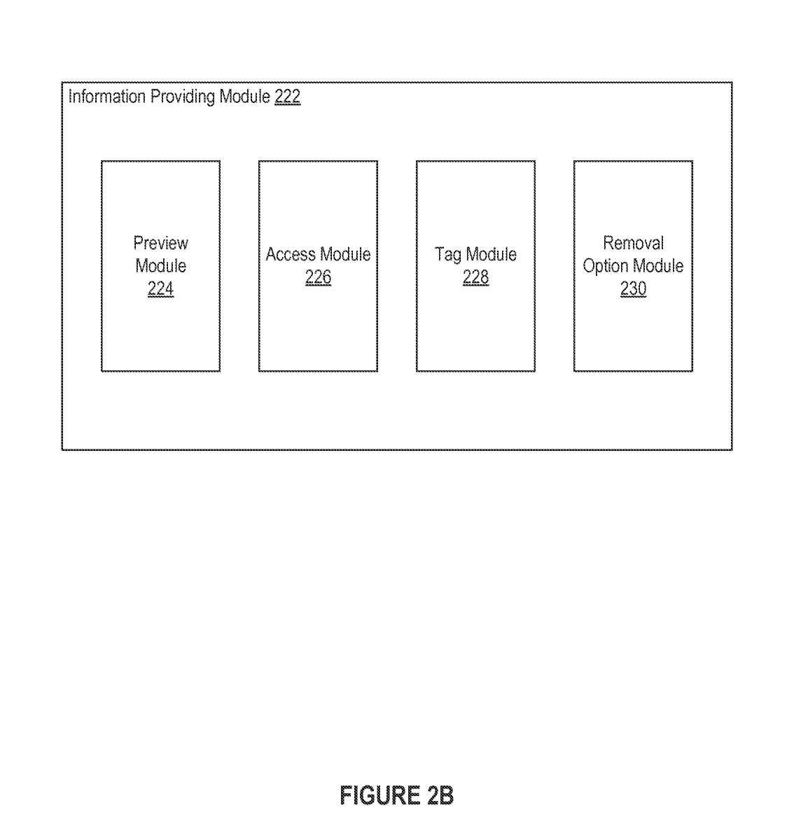

The content source module 106 can be configured to facilitate requesting a search of text associated with a set of content sources. The content source module 106 can also be configured to facilitate receiving an identification of a subset of one or more content sources, out of the set of content sources, that are each associated with respective text that at least meets a specified threshold confidence level of matching the text portion. The identification of the subset of the one or more content sources can, for example, be determined based on the requested search of the text associated with the set of content sources. More details regarding the content source module 106 will be provided below with reference to FIG. 2A.

The information providing module 108 can be configured to facilitate providing, for inclusion in (or attachment to) the communication, information associated with a selected content source out of the subset. The information can suggest, at least in part, that the text portion is attributable to the selected content source. The information providing module 108 will be discussed in more detail with reference to FIG. 2B.

Furthermore, in some embodiments, the content source attribution module 102 can be configured to communicate and/or operate with the at least one data store 110, as shown in the example system 100. The at least one data store 110 can be configured to store and maintain various types of data. In some implementations, the at least one data store 110 can store information associated with the social networking system (e.g., the social networking system 730 of FIG. 7). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user locations, user specified settings, content produced or posted by users, and various other types of user data. In some embodiments, the at least one data store 110 can store information that is utilized by the content source attribution module 102, such as text associated with various content sources. Again, it is contemplated that there can be many variations or other possibilities.

FIG. 2A illustrates an example content source module 202 configured to facilitate attributing text portions to content sources based on text analysis, according to an embodiment of the present disclosure. In some embodiments, the content source module 106 of FIG. 1 can be implemented as the example content source module 202. As shown in FIG. 2A, the content source module 202 can include a search request module 204, a content source subset identification module 206, and a content source selection module 208. Various modules, instances, and/or components of the content source module 202 can be implemented with a computing device or system (e.g., the user device 710 of FIG. 7) and/or with at least one server (e.g., one or more servers associated with the social networking system 730 of FIG. 7). It is contemplated that there can be many variations or other possibilities.

As discussed previously, the content source module 202 can facilitate requesting a search of text associated with a set of content sources. In some embodiments, the content source module 202 can utilize the search request module 204 to request the search of the text associated with the set of content sources. The set of content sources can, for instance, include at least one content source that has been shared via the social networking system. In some cases, the set of content sources can correspond to a set of content items (e.g., articles, links, media, etc.) shared and stored at the social networking system. For example, a set of URL's, articles, documents, or other content items that have already been shared via the social networking system can be stored at the social networking system. In this example, the search request module 204 can request a search of the text included in or provided by the stored set of URL's, articles, documents, or other content items. In some cases, the search request module 204 can initiate the search request when at least a specified threshold amount of text is present in a text portion to be included in a communication (e.g., when the text portion acquired by the text portion acquisition module 104 of FIG. 1 has a minimum number of characters).

In some embodiments, the search can attempt to determine whether or not the text associated with the set of content sources includes, sufficiently matches, and/or is substantially similar to the text portion. For example, the search can identify a subset of one or more content sources, out of the set of content sources, that are each associated with respective text that at least meets a specified threshold confidence level of matching the text portion. In some implementations, an instance or portion the content source subset identification module 206 can be implemented at one or more servers of the social networking system to facilitate performing the search and producing an identification of the subset, while another instance or portion of the content source subset identification module 206 can be implemented at the computing device to facilitate receiving the identification of the subset. Again, it is contemplated that there can be many variations or other possibilities.

Moreover, the content source selection module 208 can be configured to facilitate selecting a content source(s) out of the subset. In some implementations, the content source selection module 208 can facilitate ranking the subset of the one or more content sources based on a respective likelihood of each content source in the subset being relevant with respect to a user of the computing device who initiates a communication that includes the text portion. For instance, if the user and/or the user's social connections have socially interacted with (e.g., liked, shared, commented upon, etc.) a particular content source out of the subset, then the content source selection module 208 can rank the particular content source higher than others in the subset. In this instance, the content source selection module 208 can then select a content source(s) corresponding to a highest ranked content source(s) out of the subset.

In some implementations, the content source selection module 208 can enable the user to identify or select a content source(s) out of the subset. For example, the content source selection module 208 can rank and present the subset of content sources from most relevant to least relevant. Then the content source selection module 208 can accept an identification from the user for a selected content source(s) out of the subset. As discussed, many variations are possible.

FIG. 2B illustrates an example information providing module 222 configured to facilitate attributing text portions to content sources based on text analysis, according to an embodiment of the present disclosure. In some embodiments, the information providing module 108 of FIG. 1 can be implemented as the example information providing module 222. As shown in FIG. 2B, the information providing module 222 can include a preview module 224, an access module 226, a tag module 228, and a removal option module 230.

As discussed above, the information providing module 222 can facilitate providing, for inclusion in a communication, information associated with a selected content source out of a subset of content sources. The information can suggest, at least in part, that a text portion included in the communication is attributable to the selected content source. In some implementations, providing the information associated with the selected content source can further comprise providing a preview media content item associated with the selected content source, a preview text portion associated with the selected content source, and/or access (e.g., a link) to the selected content source. According, the information (e.g., the preview media content item, the preview text portion, the link, etc.) can suggest, at least in part, that the text portion is attributable to the selected content source.

In some embodiments, the information providing module 222 can utilize the preview module 224 to facilitate providing the preview media content item associated with the selected content source and/or the preview text portion associated with the selected content source. For instance, the preview module 224 can acquire an image or video from the selected content source to be provided as the preview media content item (or thumbnail media content item). In another instance, the preview module 224 can acquire a title and/or an excerpt (e.g., a representative snippet of text, a quote, etc.) from the selected content source to be provided as the preview text portion. Many variations are possible.

Moreover, in some implementations, the information providing module 222 can utilize the access module 226 to facilitate providing access to the selected content source. In some cases, the access module 226 can provide a link to the selected content source. For example, the access module 226 can cause the preview media content item and/or the preview text portion to be clickable or interactive, such that a click, tap, or another interaction with respect to the preview media content item and/or the preview text portion will link to the selected content source.

Additionally, in some embodiments, the information providing module 222 can utilize the tag module 228 to facilitate providing at least one of a tag for an entity represented in a social networking system or a link to the entity represented in the social networking system, where the entity is associated with the selected content source. For example, if the selected content source is about the entity, provided by the entity, owned by the entity, authored by the entity, or otherwise related to the entity, the tag module 228 can provide a (removable) tag to the entity for inclusion in the communication. In another example, if the text portion included in the communication is determined to correspond to a quote from the entity, then the tag module 228 can provide the (removable) tag to the entity for inclusion in the communication. In another example, if face recognition technology recognizes that the entity is depicted in the preview media content item, then the tag module 228 can also provide the (removable) tag to the entity for inclusion in the communication.

Furthermore, the information providing module 222 can utilize the removal option module 230 to facilitate providing an option to remove, from the communication, at least some of the information associated with the selected content source. For instance, the removal option module 230 can be configured to enable a user who initiated the communication to remove the preview media content item, the preview text portion, the access to the selected content source, and/or any tags. Again, it should be understood that many variations are possible.

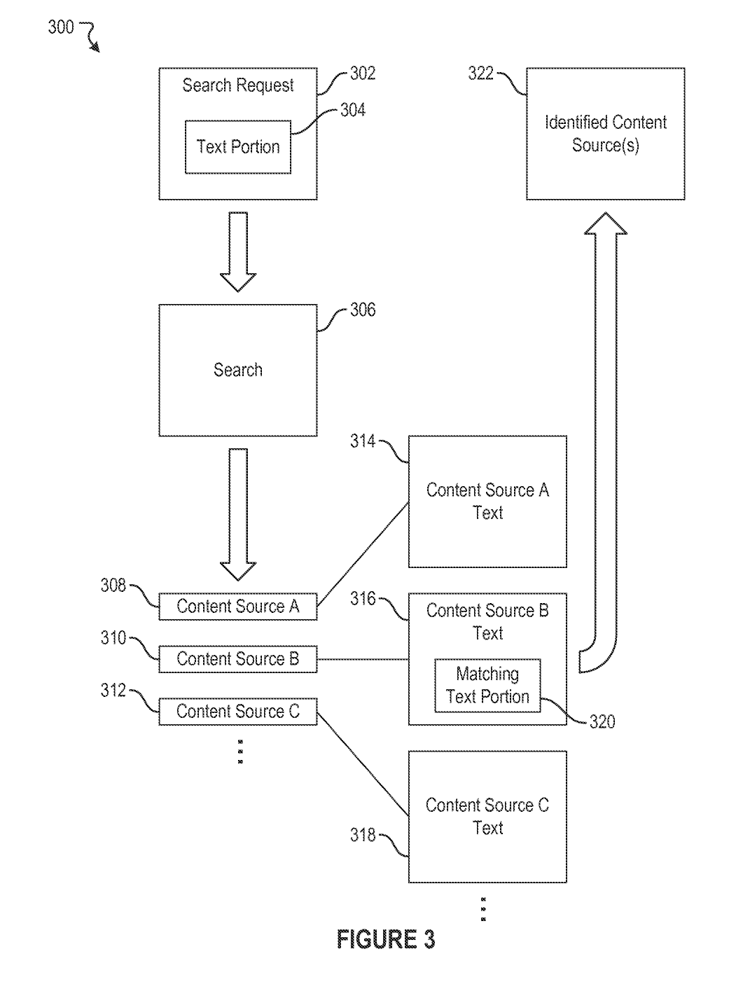

FIG. 3 illustrates an example block diagram 300 associated with attributing text portions to content sources based on text analysis, according to an embodiment of the present disclosure. At block 302, a search request including a text portion 304 can be made. The search request can initiate an analysis, including a search 306, of text associated with a set of content sources in attempt to identify content sources, if any, that have text that includes or sufficiently matches the text portion 304.

As shown in the example block diagram 300, the search 306 can be performed with respect to the set of content sources, which can include Content Source A 308, Content Source B 310, Content Source C 312, and so forth. Moreover, as shown, each content source can be associated with or can include respective text. For instance, Content Source A 308 can be associated with Content Source A Text 314, Content Source B 310 can be associated with Content Source B Text 316, Content Source C 312 can be associated with Content Source C Text 318, and so forth.

In this example, the search 306 can determine that Content Source B Text 316 includes a matching text portion 320 (e.g., text that is determined to have a specified threshold confidence level of matching the text portion 304). Accordingly, the search 306 can result in one or more identified content sources, at block 322. In this example, the one or more identified content sources, at block 322, can include Content Source B 310. It should be understood that all examples herein are provided for illustrative purposes and that there can be many variations or other possibilities associated with the disclosed technology.

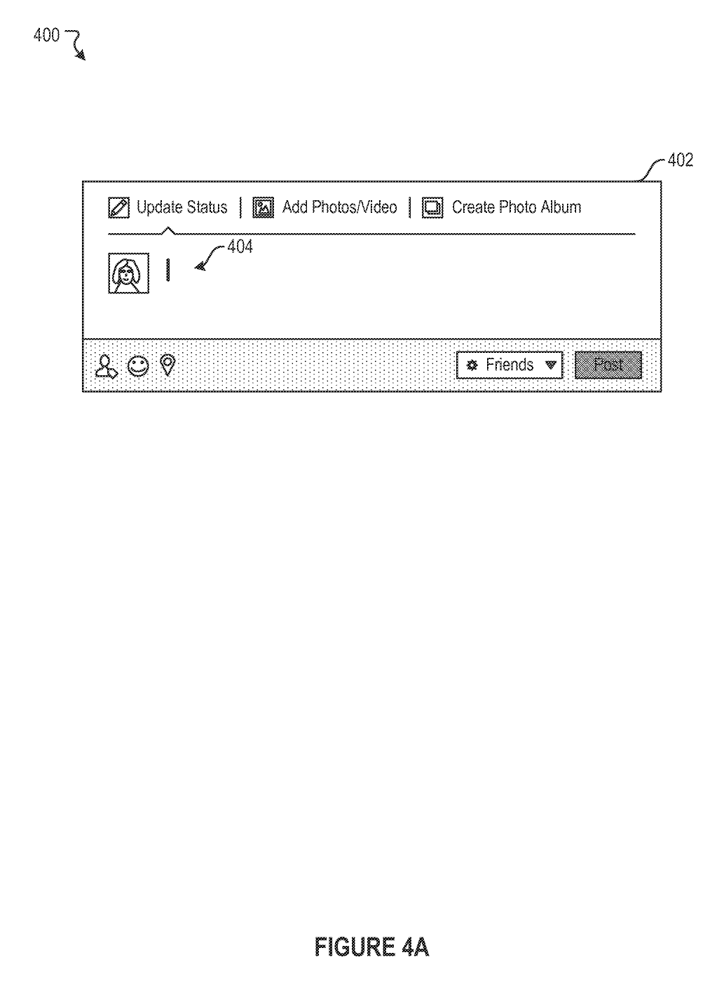

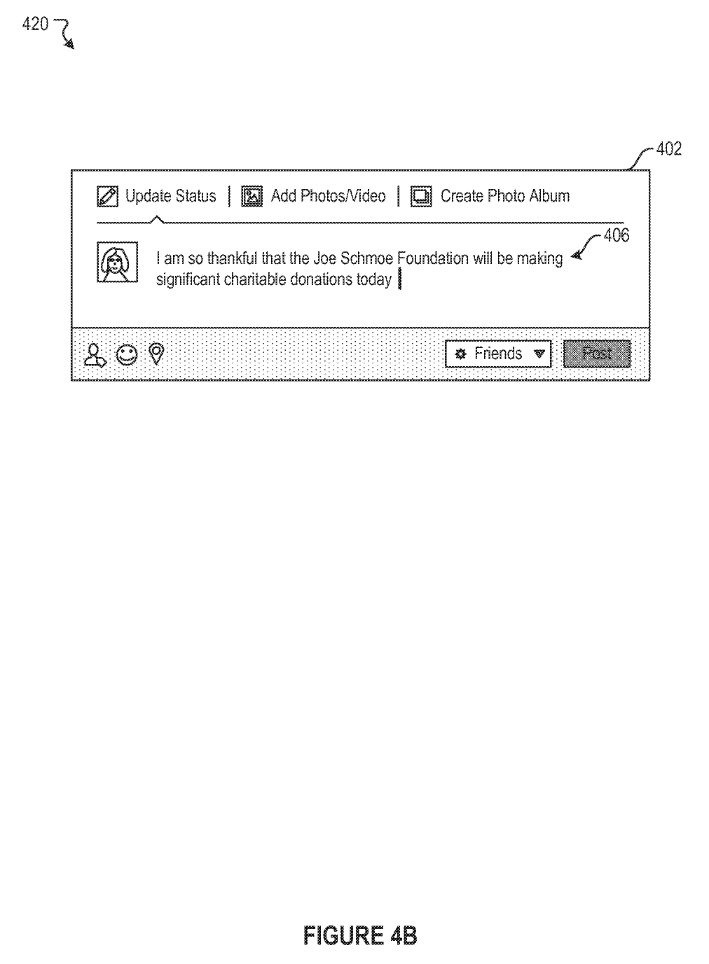

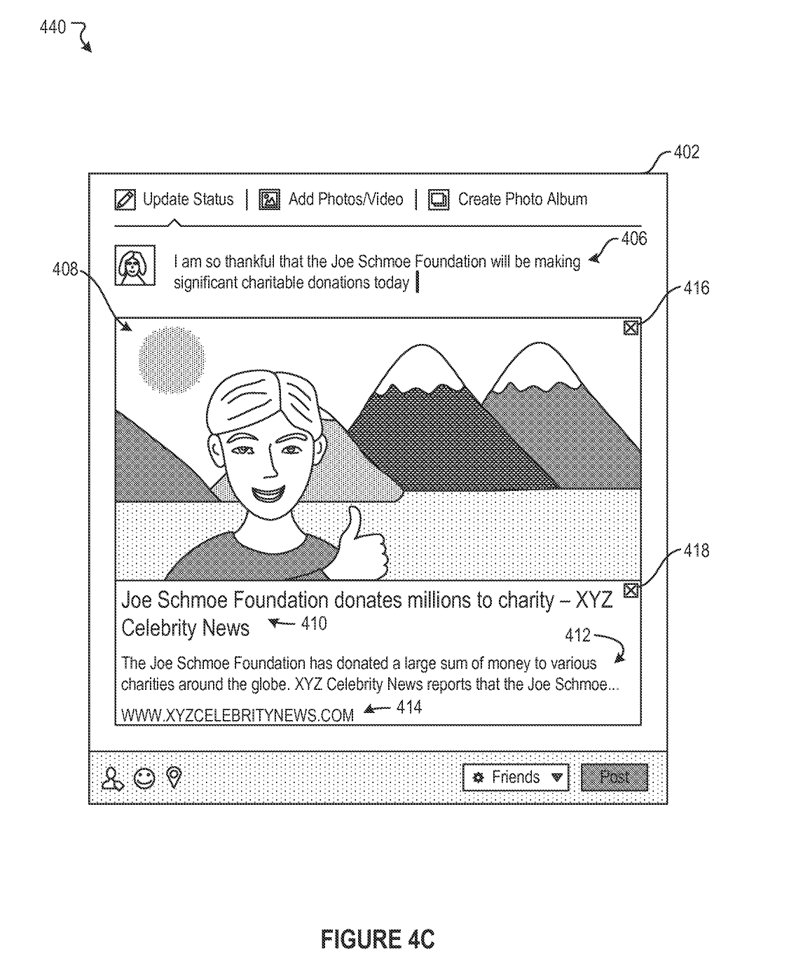

FIG. 4A illustrates an example scenario 400 associated with attributing text portions to content sources based on text analysis, according to an embodiment of the present disclosure. As shown, the example scenario 400 illustrates an interface 402 for providing a communication, such as a composer interface for generating a post or message. The interface 402 can include a text input field 404, such that a user who initiates the communication can provide text and/or other input to be included in the communication.

FIG. 4B illustrates an example scenario 420 associated with attributing text portions to content sources based on text analysis, according to an embodiment of the present disclosure. As shown, the example scenario 420 illustrates the example scenario 400 of FIG. 4A subsequent to the user having inputted a text portion (e.g., a string) 406. In the example scenario 420 of FIG. 4B, the text portion 406 is copied by the user from a particular content source and then pasted by the user into the text input field of the interface 402 to be included in the communication.

FIG. 4C illustrates an example scenario 440 associated with attributing text portions to content sources based on text analysis, according to an embodiment of the present disclosure. As shown, the example scenario 440 illustrates the example scenario 420 of FIG. 4B subsequent to having acquired the text portion 406 as input from the user. In the example scenario 440 of FIG. 4C, based on the text portion 406, the disclosed technology can identify a subset of content sources that each have text that sufficiently matches the text portion 406. Moreover, the disclosed technology can identify a selected content source out of the subset, such as a most relevant content source or a user-selected content source.

As shown, information associated with the selected content source can be provided. In the example scenario 440, a preview media content item (e.g., an image 408 from the selected content source), a preview text portion (e.g., a title 410 of the selected content source, a sample excerpt or quote 412 from the selected content source, etc.), and access (e.g., a link, URL, or web address 414) to the selected content source can be presented. Moreover, the disclosed technology can provide one or more options (e.g., via button 416 and/or button 418) to remove at least some of the information associated with the selected content source, such as the preview media content item, the preview text portion, and/or the access to the selected content source. As discussed above, it should be appreciated that all examples herein are provided for illustrative purposes and that many variations are possible.

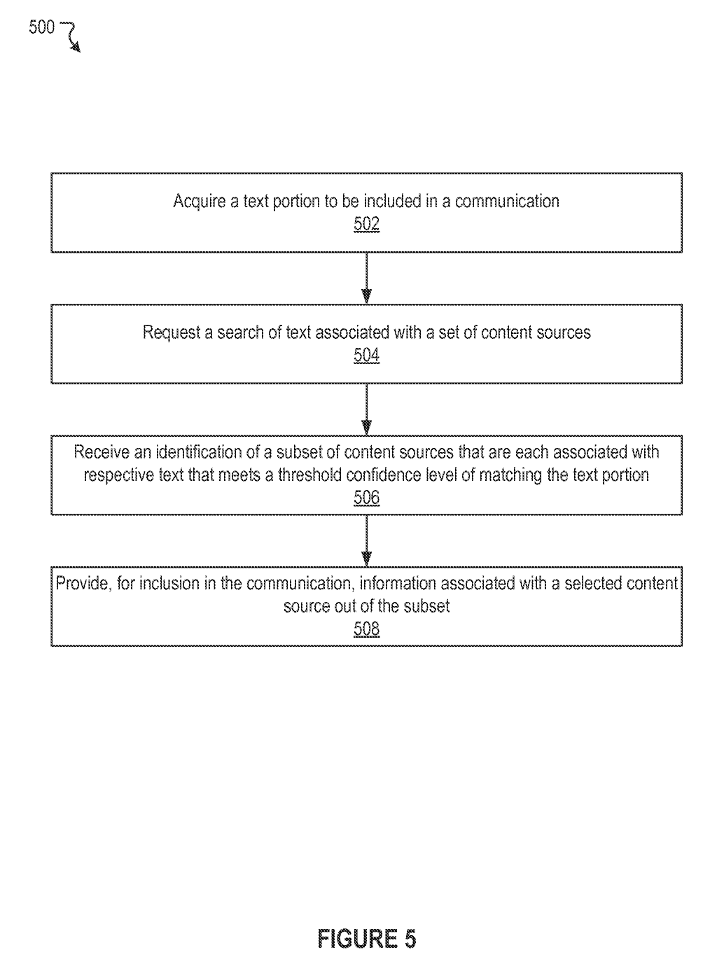

FIG. 5 illustrates an example method 500 associated with attributing text portions to content sources based on text analysis, according to an embodiment of the present disclosure. It should be appreciated that there can be additional, fewer, or alternative steps performed in similar or alternative orders, or in parallel, within the scope of the various embodiments unless otherwise stated.

At block 502, the example method 500 can acquire a text portion to be included in a communication. At block 504, the example method 500 can request a search of text associated with a set of content sources. At block 506, the example method 500 can receive an identification of a subset of one or more content sources, out of the set of content sources, that are each associated with respective text that at least meets a specified threshold confidence level of matching the text portion. At block 508, the example method 500 can provide, for inclusion in the communication, information associated with a selected content source out of the subset. The information can suggest, at least in part, that the text portion is attributable to the selected content source.

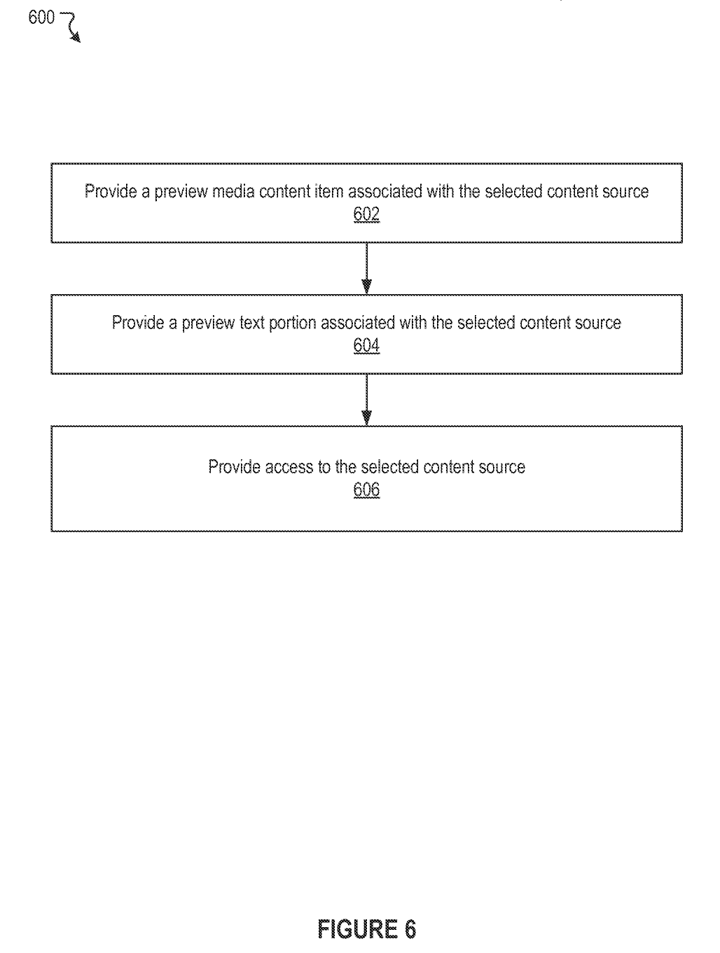

FIG. 6 illustrates an example method 600 associated with attributing text portions to content sources based on text analysis, according to an embodiment of the present disclosure. As discussed, it should be understood that there can be additional, fewer, or alternative steps performed in similar or alternative orders, or in parallel, within the scope of the various embodiments unless otherwise stated.

At block 602, the example method 600 can provide a preview media content item associated with the selected content source. At block 604, the example method 600 can provide a preview text portion associated with the selected content source. At block 606, the example method 600 can provide access to the selected content source.

It is contemplated that there can be many other uses, applications, features, possibilities, and/or variations associated with the various embodiments of the present disclosure. For example, in some instances, users can choose whether or not to opt-in to utilize the disclosed technology. The disclosed technology can, for instance, also ensure that various privacy settings and preferences are maintained and can prevent private information from being divulged. In another example, various embodiments of the present disclosure can learn, improve, and/or be refined over time.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the Silverlight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the user device 710 can include a content source attribution module 718. The content source attribution module 718 can, for example, be implemented as the content source attribution module 102 of FIG. 1. As discussed previously, it should be appreciated that there can be many variations or other possibilities. For example, in some instances, the content source attribution module 718 (or at least a portion thereof) can be included or implemented in the social networking system 730. Other features of the content source attribution module 718 are discussed herein in connection with the content source attribution module.

### Hardware Implementation

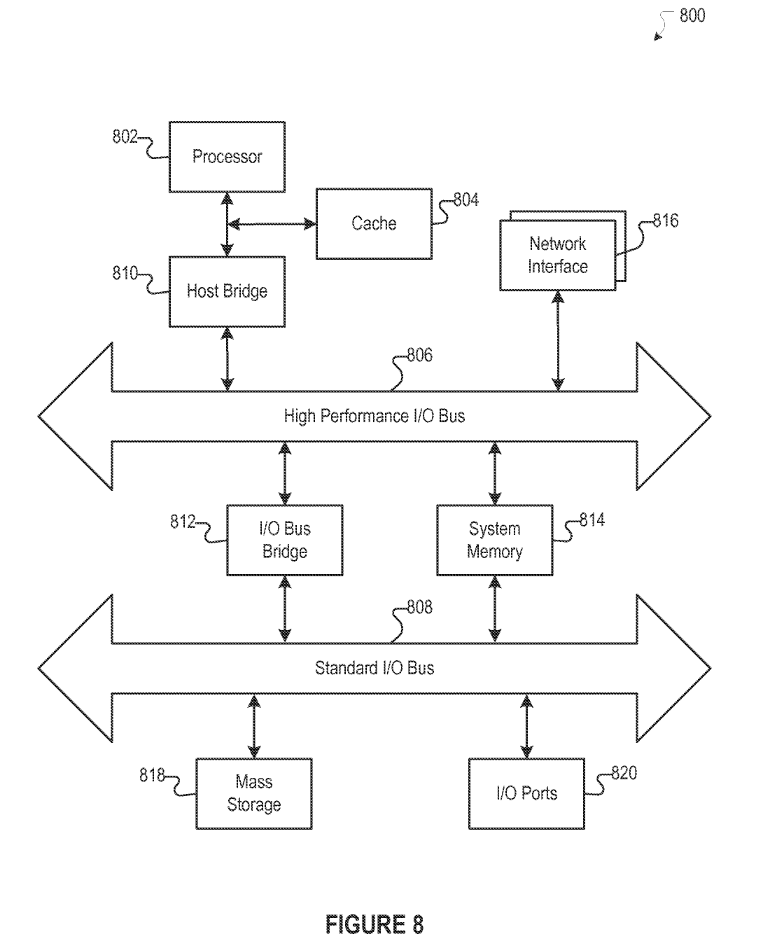

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments. Furthermore, reference in this specification to “based on” can mean “based, at least in part, on”, “based on at least a portion/part of”, “at least a portion/part of which is based on”, and/or any combination thereof.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
acquiring, by a computing system, a text portion to be included in a communication;
requesting, by the computing system, a search of text associated with a set of content sources;
receiving, by the computing system, an identification of a subset of one or more content sources, out of the set of content sources, that are each associated with respective text that at least meets a specified threshold confidence level of matching the text portion; and
providing, by the computing system, for inclusion in the communication, information associated with a selected content source out of the subset, the information suggesting, at least in part, that the text portion is attributable to the selected content source.

2. The computer-implemented method of claim 1, wherein providing, for inclusion in the communication, the information associated with the selected content source further comprises:
providing a preview media content item associated with the selected content source;
providing a preview text portion associated with the selected content source; and
providing access to the selected content source.

3. The computer-implemented method of claim 1, further comprising:
providing an option to remove, from the communication, at least some of the information associated with the selected content source.

4. The computer-implemented method of claim 1, further comprising:
ranking the subset of the one or more content sources based on a respective likelihood of each content source in the subset being relevant with respect to a user who initiates the communication.

5. The computer-implemented method of claim 4, wherein the selected content source corresponds to a highest ranked content source out of the subset.

6. The computer-implemented method of claim 1, wherein the selected content source is identified by a user who initiates the communication.

7. The computer-implemented method of claim 1, wherein the text portion is acquired based on a paste operation from a user who initiates the communication.

8. The computer-implemented method of claim 1, wherein requesting the search of the text associated with the set of content sources is initiated when at least a specified threshold amount of text is present in the text portion.

9. The computer-implemented method of claim 1, further comprising:
providing at least one of a tag for an entity represented in a social networking system or a link to the entity represented in the social networking system, the entity being associated with the selected content source.

10. The computer-implemented method of claim 1, wherein the set of content sources includes at least one content source that has been shared via a social networking system.

11. A system comprising:
at least one processor; and
a memory storing instructions that, when executed by the at least one processor, cause the system to perform:
acquiring a text portion to be included in a communication;
requesting a search of text associated with a set of content sources;
receiving an identification of a subset of one or more content sources, out of the set of content sources, that are each associated with respective text that at least meets a specified threshold confidence level of matching the text portion; and
providing, for inclusion in the communication, information associated with a selected content source out of the subset, the information suggesting, at least in part, that the text portion is attributable to the selected content source.

12. The system of claim 11, wherein providing, for inclusion in the communication, the information associated with the selected content source further comprises:
providing a preview media content item associated with the selected content source;
providing a preview text portion associated with the selected content source; and
providing access to the selected content source.

13. The system of claim 11, wherein the instructions cause the system to further perform:
providing an option to remove, from the communication, at least some of the information associated with the selected content source.

14. The system of claim 11, wherein the instructions cause the system to further perform:
ranking the subset of the one or more content sources based on a respective likelihood of each content source in the subset being relevant with respect to a user who initiates the communication.

15. The system of claim 11, wherein the text portion is acquired based on a paste operation from a user who initiates the communication.

16. A non-transitory computer-readable storage medium including instructions that, when executed by at least one processor of a computing system, cause the computing system to perform a method comprising:
acquiring a text portion to be included in a communication;
requesting a search of text associated with a set of content sources;
receiving an identification of a subset of one or more content sources, out of the set of content sources, that are each associated with respective text that at least meets a specified threshold confidence level of matching the text portion; and
providing, for inclusion in the communication, information associated with a selected content source out of the subset, the information suggesting, at least in part, that the text portion is attributable to the selected content source.

17. The non-transitory computer-readable storage medium of claim 16, wherein providing, for inclusion in the communication, the information associated with the selected content source further comprises:
providing a preview media content item associated with the selected content source;
providing a preview text portion associated with the selected content source; and
providing access to the selected content source.

18. The non-transitory computer-readable storage medium of claim 16, wherein the instructions cause the computing system to further perform:
providing an option to remove, from the communication, at least some of the information associated with the selected content source.

19. The non-transitory computer-readable storage medium of claim 16, wherein the instructions cause the computing system to further perform:
ranking the subset of the one or more content sources based on a respective likelihood of each content source in the subset being relevant with respect to a user who initiates the communication.

20. The non-transitory computer-readable storage medium of claim 16, wherein the text portion is acquired based on a paste operation from a user who initiates the communication.
